(19) United States
(12) Patent Application Publication
(10) Pub. No.: US 2024/0317033 A1
(43) Pub. Date: Sep. 26, 2024

(54) SUNROOF APPARATUS

(71) Applicants: AISIN CORPORATION, Kariya-shi, Aichi-ken (JP); KABUSHIKI KAISHA TOYOTA JIDOSHOKKI, Kariya-shi, Aichi-ken (JP)

(72) Inventors: Jun MATSUSHITA, Kariya-shi (JP); Yuichi MIZUTANI, Kariya-shi (JP); Muneaki INAGAKI, Kariya-shi (JP)

(73) Assignees: AISIN CORPORATION, Kariya-shi, Aichi-ken (JP); KABUSHIKI KAISHA TOYOTA JIDOSHOKKI, Kariya-shi, Aichi-ken (JP)

(21) Appl. No.: 18/577,192

(22) PCT Filed: Jun. 9, 2022
(86) PCT No.: PCT/JP2022/023241

§ 371 Date: Jan. 5, 2024

(30) Foreign Application Priority Data
Jul. 8, 2021 (JP) 2021-113585

(51) Int. Cl. B60J 7/043; B60J 7/00; B60J 7/22

(52) U.S. Cl. CPC B60J 7/043; B60J 7/0084; B60J 7/22

(57) ABSTRACT

A sunroof apparatus (1) includes a roof panel (10), a panel body (41), and a base panel (20). The roof panel (10) is attached so as to cover a roof opening (3a) of a vehicle. The panel body (41) opens and closes a panel opening (11) provided in the roof panel (10). The base panel (20) is attached to a vehicle interior side of the panel opening (11), and extends along a periphery of the panel opening (11). A groove (26) is formed between the base panel (20) and the panel body (41). Drain members (90, 100) are attached to the groove (26). The drain members (90, 100) have at least one connection channel (92, 102) that connects between an inside and an outside of the base panel (20). The connection channel (92, 102) is coupled to a drainage channel (110) provided in a vehicle frame (2).

### TECHNICAL FIELD

This disclosure relates to a sunroof apparatus.

### BACKGROUND ART

For example, a vehicle roof apparatus disclosed in PTL 1 is mounted on a roof of a vehicle. The vehicle roof apparatus includes a resin roof panel. The resin roof panel covers a body opening formed in the roof of the vehicle. The resin roof panel includes an opening portion. The opening portion of the resin roof panel is opened and closed by a roof window.

### CITATION LIST

### Patent Literature

PTL 1: JP2020-66285A

### SUMMARY OF INVENTION

### Technical Problem

A groove is formed between the resin roof panel described above and the roof window. Water between the resin roof panel and the roof window may enter the groove formed in this manner. That is, there is room for improvement in a method of treating water entering between the resin roof panel and the roof window.

### Solution to Problem

A sunroof apparatus according to an aspect of the present disclosure includes: a roof panel attached to cover a roof opening provided in a roof of a vehicle; a panel body configured to open and close a panel opening provided in the roof panel; and a base panel attached to an vehicle interior side of the panel opening and extending along a periphery of the panel opening. A groove is formed between the base panel and the panel body, the groove has at least one connection channel communicating an inside and an outside of the base panel, and each the connection channel is coupled to a drainage channel provided in a body of the vehicle.

For example, when water enters between the roof panel and the panel body, the entering water reaches the groove of the base panel. The water that reaches the groove in this manner discharges outside the base panel through the connection channel while flowing through the groove. The water discharged to the outside of the base panel flows to the drainage channel of the body of the vehicle to which the connection channel is coupled. Accordingly, the water entering between the roof panel and the panel body is discharged from the groove of the base panel to the drainage channel via the connection channels in this order, so that the water is prevented from entering to the vehicle interior. Accordingly, water entering between the roof panel and the panel body can be appropriately treated.

In the sunroof apparatus described above, the groove may extend continuously along the base panel, and the at least one connection channel may be provided in a portion that becomes a lowest point in the groove extending continuously.

According to the above configuration, the water entering between the roof panel and the panel body suitably flows into the connection channel. Accordingly, water entering between the roof panel and the panel body can be suitably discharged from the groove of the base panel.

In the sunroof apparatus described above, the roof opening may have a rectangular shape, an outer shell of the roof panel may have a rectangular shape following the roof opening and includes four corners, when the vehicle is placed on a flat horizontal surface, portions corresponding to the four corners of the roof panel may be located lower as compared with a center portion, and portions corresponding to two front corners of the four corners may be lowest, the panel opening may have a rectangular shape, the base panel may be a rectangular frame following the panel opening and includes four corner portions, the groove may include four groove portions respectively corresponding to the four corners of the frame, the four groove portions may include two front corner groove portions and two rear corner groove portions, and the at least one connection channel may include two connection channels that respectively open to the two front corner groove portions.

According to the above configuration, when the vehicle is placed on a flat horizontal surface, the water that reaches the groove suitably flows to the front corner groove portion. Accordingly, the water entering between the roof panel and the panel body suitably flows into the connection channel. Accordingly, the water entering between the roof panel and the panel body can be suitably discharged from the groove of the base panel.

In the sunroof apparatus described above, the at least one connection channel may further include two connection channels that respectively open to the two rear corner groove portions. According to the above configuration, when the vehicle is placed on an inclined surface (that is, the vehicle is inclined with respect to the horizon), for example, when the front side of the vehicle is located on the upper side with respect to the rear side, the water that reaches the groove flows to the rear corner groove portion of the vehicle. Accordingly, the water entering between the roof panel and the panel body suitably flows into the connection channel even when the vehicle is inclined with respect to the horizon. That is, water entering between the roof panel and the panel body suitably flows into the connection channel regardless of conditions (inclination) of the vehicle. Accordingly, the water entering between the roof panel and the panel body can be suitably discharged from the groove of the base panel.

The sunroof apparatus described above may further include: a deflector device configured to prevent air vibration caused by wind being drawn into a vehicle interior when the panel opening is opened. The deflector device may be accommodated in the groove in the base panel, the at least one connection channel may be a part of a drain member provided separately from the base panel, and the drain member may be attached to the base panel in a state of supporting the deflector device.

According to the above configuration, the drain member can also serve as a configuration for supporting the deflector device. Accordingly, the configuration can be simplified as compared with a case where a configuration component for supporting the deflector device is individually provided.

The sunroof apparatus described above may further include: a panel device configured to perform an opening operation and a closing operation on the panel body; and a shade device configured to perform an opening operation and a closing operation on a light shielding member provided below the panel body. The panel device may be attached to the vehicle interior side of the base panel via a base bracket in a range of the roof panel where the base panel exists, and the shade device may be attached to the vehicle interior side of the roof panel via a panel bracket in a range of the roof panel where the base panel does not exist.

According to the above configuration, the panel device can be attached to the base panel via the base bracket. On the other hand, the shade device can be attached to the roof panel via the panel bracket even in a range where the base panel does not exist. Accordingly, when the panel device and the shade device are provided, each device can be suitably attached to the roof panel.

### BRIEF DESCRIPTION OF DRAWINGS

FIG. 1 is a schematic diagram of a sunroof apparatus according to an embodiment.

FIG. 2 is a schematic view showing an exploded structure of the sunroof apparatus of FIG. 1.

FIG. 3 is an end view taken along a line Ill-Ill in FIG. 1.

FIG. 4 is an end view taken along a line IV-IV in FIG. 1.

FIG. 5 is an end view taken along a line V-V in FIG. 1.

FIG. 6 is an end view taken along a line VI-VI in FIG. 1.

FIG. 7 is an end view taken along a line VII-VII in FIG. 1.

FIG. 8 is a schematic view showing a groove of a base panel of FIG. 2.

FIG. 9 is an enlarged view of a range A in FIG. 8.

FIG. 10 is an enlarged view of a range B in FIG. 8.

FIG. 11 is a schematic view showing a configuration for supporting a lower frame with respect to a front drain member of FIG. 8.

### DESCRIPTION OF EMBODIMENTS

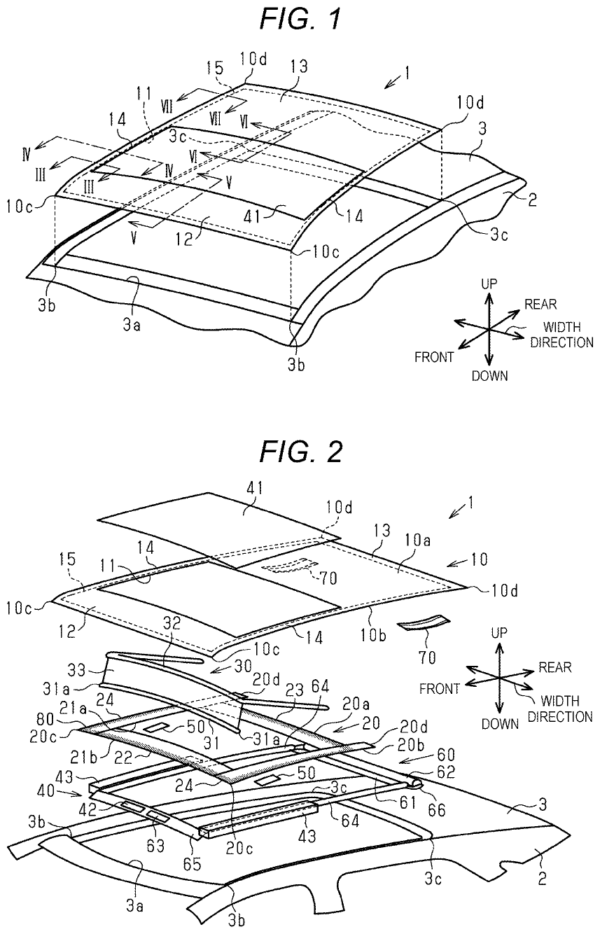

Hereinafter, a sunroof apparatus 1 according to an embodiment will be described with reference to FIGS. 1 to 11.

As shown in FIG. 1, a vehicle includes a vehicle frame 2. The vehicle frame 2 includes a roof 3. A roof opening 3a is provided in the roof 3. The sunroof apparatus 1 is attached to the roof 3 so as to cover the roof opening 3a. A shape of the roof 3 is rectangular when viewed from above the vehicle. The roof 3 has a curved shape such that, when the vehicle is placed on a flat horizontal surface, portions 3b and 3c corresponding to four corners are located lower as compared with a center portion, and the two portions 3b corresponding to two front corners of the four corners are lowest points. The roof opening 3a has a rectangular shape. The sunroof apparatus 1 is a part of the roof 3. In FIGS. 1 and 2, a left front side corresponds to a front side of the vehicle, and a right rear side corresponds to a rear side of the vehicle. In FIGS. 1 and 2, an up side corresponds to an up side of the vehicle, and a down side corresponds to a down side of the vehicle. In the present disclosure, directions represented by terms such as “front”, “rear”, “up”, and “down” are defined with reference to the vehicle. A direction of the vehicle orthogonal to a “front-rear direction” and an “up-down direction” means a “width direction” of the vehicle.

### <Configuration of Sunroof Apparatus>

As shown in FIGS. 1 and 2, the sunroof apparatus 1 includes a roof panel 10, a base panel 20, a deflector device 30, a panel device 40, a base bracket 50, a shade device 60, and a panel bracket 70.

### <Configuration of Roof Panel>

A high molecular material such as synthetic resin is used for the roof panel 10. An outer shell of the roof panel 10 has a rectangular shape following the roof opening 3a. The roof panel 10 covers most of the roof 3 in the front-rear direction and the width direction of the roof 3 from above. That is, when the vehicle is placed on a flat horizontal surface, the roof panel 10 is curved such that portions 10c and 10d (two front corner portions 10c and two rear corner portions 10d) corresponding to four corners are located lower as compared with a center portion, and the two portions 10c corresponding to two front corners are lowest points. The roof panel 10 includes a panel opening 11, a panel front portion 12, a panel rear portion 13, and two panel side portions 14.

The panel opening 11 has a rectangular shape. The panel opening 11 penetrates the roof panel 10 in a thickness direction. The panel opening 11 is disposed in front of a center of the roof panel 10 in the front-rear direction. In a state where the roof panel 10 is attached to the roof 3, an inside and an outside of the vehicle communicate with each other through the panel opening 11. A panel body 41 is fitted into the panel opening 11. In the embodiment disclosed here, the panel body 41 is made of glass. The same material as that of the roof panel 10 can be used for the panel body 41, for example, but one or more materials different from that of the roof panel 10 may be used for the panel body 41. A shape of the panel body 41 is the same as the shape of the panel opening 11. An outer edge of the panel body 41 is slightly smaller than an inner edge of the panel opening 11. The panel body 41 performs an opening operation and a closing operation to open and close the panel opening 11. When the panel opening 11 is closed, the panel body 41 is accommodated in the panel opening 11 such that an upper surface of the panel body 41 is flush with a first surface 10a which is an upper surface of the roof panel 10. On the other hand, when the panel opening 11 is opened, the panel body 41 moves upward of the roof panel 10 to take a forward tilting posture, and moves in the front-rear direction, for example, to the rear side. In the embodiment disclosed here, the panel body 41 is an outer-slide type that performs the opening operation upward of the roof panel 10. The panel body 41 may be an inner slide type that performs the opening operation downward of the roof panel 10.

The panel front portion 12 is located in front of the panel opening 11. The panel rear portion 13 is located behind the panel opening 11, that is, behind the center of the roof panel 10. The two panel side portions 14 are located on two outer sides of the panel opening 11 in the width direction, respectively. On a second surface 10b which is a lower surface of the roof panel 10, a front end of the panel front portion 12, a rear end of the panel rear portion 13, and outer ends of the two panel side portions 14 in the width direction are fixed to the vehicle frame 2 by urethane resin 15. As a method of fixing the roof panel 10, for example, fastening of rivets, bolts, or the like or engagement of claws or the like can be used, but the method is not limited thereto.

### <Configuration of Base Panel>

A metal material such as iron or aluminum is used for the base panel 20. An outer shell of the base panel 20 has a rectangular shape following the panel opening 11. The base panel 20 is a rectangular frame and includes four corner portions 20c and 20d. An inner edge 21a of the base panel 20 is smaller than the inner edge of the panel opening 11, and an outer edge 21b is larger than the inner edge of the panel opening 11. A first surface 20a which is an upper surface of the base panel 20 is fixed to the second surface 10b of the roof panel 10 by urethane resin 80. As a method of fixing the base panel 20 to the roof panel 10, for example, fastening of rivets, bolts, or the like or engagement of claws or the like can be used, but the method is not limited thereto. A second surface 20b which is a lower surface of the base panel 20 is fixed to the vehicle frame 2 via a bracket (not shown). As a method of fixing the base panel 20 to the vehicle frame 2, for example, fastening of rivets, bolts, or the like or engagement of claws or the like can be used, but the method is not limited thereto.

The base panel 20 includes a base front portion 22, a base rear portion 23, and two base side portions 24. The first surface 20a of the base front portion 22 is fixed to the panel front portion 12. The first surface 20a of the base rear portion 23 is fixed to the panel rear portion 13 around the panel opening 11. That is, a portion of the panel rear portion 13 of the roof panel 10 around the panel opening 11 is a portion in a range where the base panel 20 exists. Each base side portion 24 is fixed to the corresponding panel side portion 14. Front ends of the two base side portions 24 are connected to each other by the base front portion 22. Rear portions of the two base side portions 24 are connected to each other by the base rear portion 23. Each of rear ends of the two base side portions 24 extends further rearward beyond the base rear portion 23. Portions where the two base side portions 24 and the base front portion 22 are connected are the two front corner portions 20c of the base panel 20. Portions of the two base side portions 24 that extend further rearward beyond the base rear portion 23 are the two rear corner portions 20d of the base panel 20. When the vehicle is placed on a flat horizontal surface, the corner portions 20c and 20d of the base panel 20 are located lower as compared with a center portion, and the two front corner portions 20c are lowest points.

### <Configuration of Deflector Device>

The deflector device 30 includes a lower frame 31, an upper frame 32, and a deflector portion 33. A high molecular material such as synthetic resin is used for the lower frame 31. The lower frame 31 has a columnar shape. An axis of the lower frame 31 coincides with the width direction. Two end portions 31a of the lower frame 31 in an axial direction thereof are fixed to the first surface 20a of the base front portion 22.

A high molecular material such as synthetic resin is used for the upper frame 32. The upper frame 32 has a C shape obtained by coupling columnar members. Axes of two arm portions of the upper frame 32 extending in the front-rear direction coincide with a front-rear upper side. Front ends of the two arm portions are connected to each other by a front portion. An axis of the front portion coincides with the width direction. Each of rear ends of the two arm portions is fixed to the first surface 20a of the base side portion 24. The upper frame 32 is rotatable about the rear ends of the two arm portions, so that a front portion thereof approaches and separates from the first surface 20a of the base front portion 22. In the embodiment disclosed here, the front portion of the upper frame 32 is biased in a direction away from the first surface 20a of the base front portion 22 by a biasing member such as a spring (not shown).

The deflector portion 33 is a mesh member woven with nylon or the like in a mesh shape. The deflector portion 33 has a rectangular shape. The deflector portion 33 is spanned between the lower frame 31 and the upper frame 32. Accordingly, when the panel body 41 performs the opening operation, the front portion of the upper frame 32 of the deflector device 30 rotates in a direction away from the first surface 20a of the base front portion 22. In this case, the deflector portion 33 is in a deployed state having a flat surface on the front side, so that the deflector portion 33 prevent air vibration caused by wind being drawn into a vehicle interior when the panel opening 11 is opened. On the other hand, when the panel body 41 performs the closing operation, the front portion of the upper frame 32 of the deflector device 30 rotates in a direction approaching the first surface 20a of the base front portion 22. In this case, the deflector portion 33 is accommodated in the base panel 20 by being in a folded state.

### <Configuration of Panel Device>

The panel device 40 includes the panel body 41, a driving device 42, and two guide rails 43. The driving device 42 generates a driving force for performing the opening operation and the closing operation on the panel body 41. Each guide rail 43 is disposed along the corresponding base side portion 24. The two guide rails 43 are disposed at a predetermined interval in the width direction. Each guide rail 43 extends in the front-rear direction along the corresponding base side portion 24. The guide rail 43 guides the opening operation and the closing operation of the panel body 41. Each guide rail 43 is fixed to the second surface 20b of the corresponding base side portion 24 via the base bracket 50. The base bracket 50 has a flat plate shape. The panel device 40 includes the two base brackets 50 respectively corresponding to the two base side portions 24. Each base bracket 50 couples the corresponding guide rail 43 to the base panel 20. The two guide rails 43 are fixed to the corresponding base brackets 50 by using fastening of rivets, bolts, or the like. Thus, the panel device 40 is fixed to the base panel 20. As a method of fixing the guide rail 43 to the base bracket 50, for example, engagement of claws or the like or adhesion of an adhesive or the like can be used, but the method is not limited thereto.

### <Configuration of Shade Device>

The shade device 60 includes a shade 61, a shade winding portion 62, a driving device 63, two guide rails 64, a front portion 65, and a rear portion 66. The shade 61 is a light shielding sheet as a light shielding member. The shade 61 is, for example, a plate-shaped light shielding member, but is not limited thereto. The shade winding portion 62 is a rotating body that winds the shade 61. The driving device 63 generates a driving force for winding up and feeding out the shade 61 with respect to the shade winding portion 62. Each guide rail 64 is disposed along the corresponding base side portion 24. The two guide rails 64 are disposed at a predetermined interval in the width direction. Each guide rail 64 extends in the front-rear direction along the corresponding base side portion 24 inside the corresponding guide rail 43 in the width direction. The guide rail 64 guides operations when winding up and feeding out the shade 61. Front ends of the two guide rails 64 are connected to each other by the front portion 65. The front portion 65 extends in the width direction. Rear ends of the two guide rails 64 are connected to each other by the rear portion 66. The rear portion 66 extends in the width direction. The driving device 63 and the driving device 42 of the panel device 40 are attached to the front portion 65. The shade winding portion 62 is attached to the rear portion 66.

Each guide rail 64 is fixed to the second surface 20b of the corresponding base side portion 24 via the base bracket 50. The two base brackets 50 couple the guide rails 64 to the base panel 20 together with the corresponding guide rails 43 of the panel device 40. The two guide rails 64 are fixed to the corresponding base brackets 50 by using fastening of rivets, bolts, or the like. The rear portion 66 is fixed to the second surface 10b of the roof panel 10 via the panel bracket 70. The panel bracket 70 has a flat plate shape. The two panel brackets 70 are provided on both sides of the roof panel 10 in the width direction, respectively. The two panel brackets 70 couple the rear portion 66 to the roof panel 10. The rear portion 66 is fixed to the two panel brackets 70 by using fastening of rivets, or the like. Thus, the shade device 60 is fixed to the base panel 20 and the roof panel 10. As a method of fixing the rear portion 66 to the panel bracket 70, for example, engagement of claws or the like or adhesion of an adhesive or the like can be used, but the method is not limited thereto.

The shade 61 performs the opening operation and the closing operation to open and close the second surface 10b of the roof panel 10. When the shade 61 closes the second surface 10b of the roof panel 10, the shade 61 is fed out of the shade winding portion 62 and performs the closing operation from the rear side to the front side so as to be in the deployed state. On the other hand, when the shade 61 opens the second surface 10b of the roof panel 10, the shade 61 performs the opening operation from the front side toward the rear side so as to be wound up around the shade winding portion 62.

### <Detailed Configuration of Base Panel>

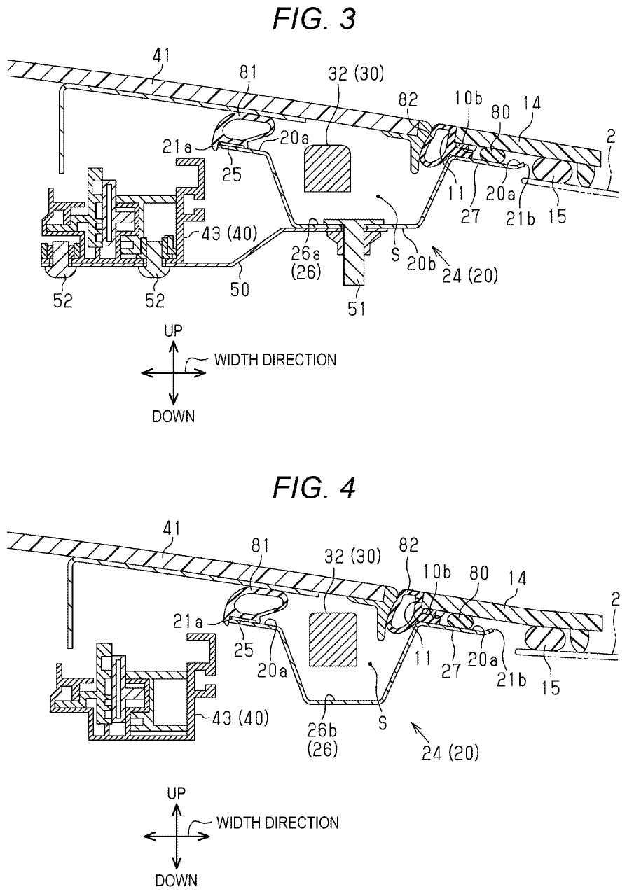

FIGS. 3 to 6 show the panel body 41 in the closed state. As shown in FIGS. 3 to 6, the base panel 20 includes a first support portion 25, a groove 26, and a second support portion 27. The first support portion 25, the groove 26, and the second support portion 27 are disposed in this order from the inner edge 21a toward the outer edge 21b. The first support portion 25 continuously extends across the base front portion 22, the base rear portion 23, and the two base side portions 24. The first support portion 25 is a portion closest to the inner edge 21a. The groove 26 continuously extends across the base front portion 22, the base rear portion 23, and the two base side portions 24. The groove 26 continuously extends along the two base side portions 24 to the rear side of the base rear portion 23, that is, to the two corner portions 20d. The groove 26 is separated from the inner edge 21a with respect to the first support portion 25. The groove 26 is located below the first support portion 25, that is, on a vehicle interior side. The second support portion 27 continuously extends across the base front portion 22, the base rear portion 23, and the two base side portions 24. The second support portion 27 is located closest to the outer edge 21b and between the first support portion 25 and the groove 26 in the up-down direction.

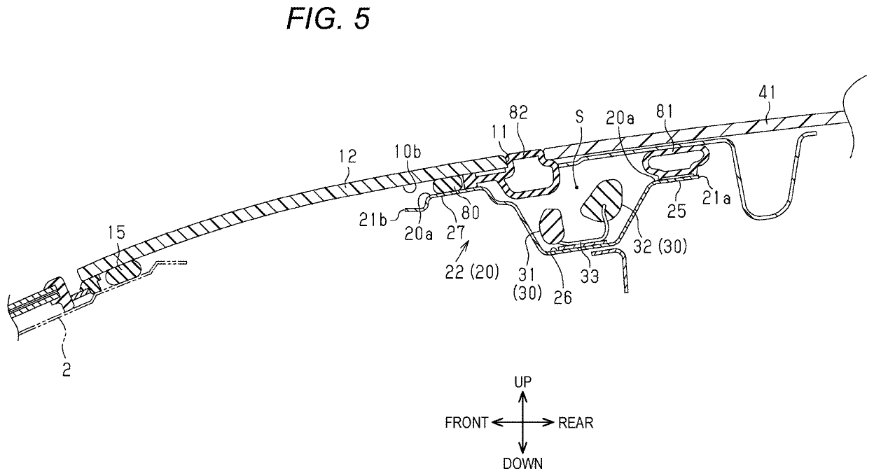

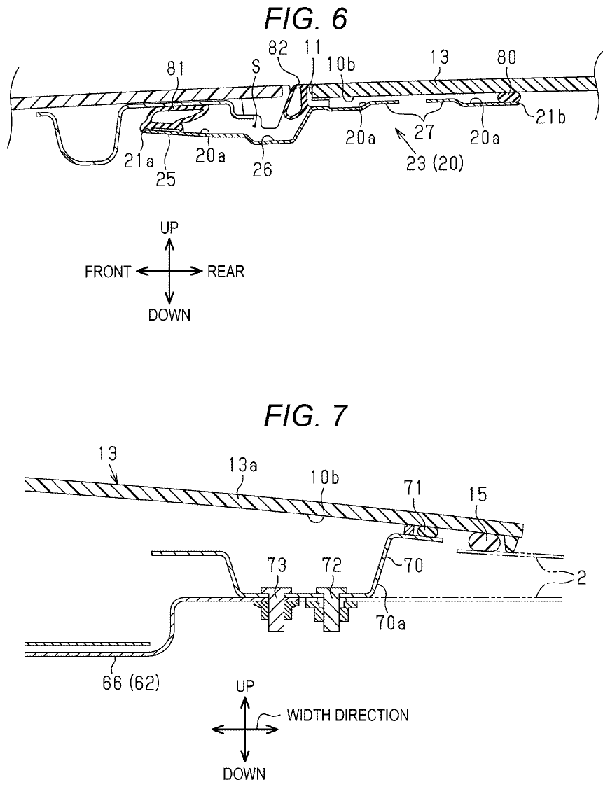

FIGS. 3 and 4 show the first support portion 25, the groove 26, and the second support portion 27 located along the base side portion 24. FIG. 5 shows the first support portion 25, the groove 26, and the second support portion 27 located along the base front portion 22. FIG. 6 shows the first support portion 25, the groove 26, and the second support portion 27 located along the base rear portion 23.

Referring back to FIGS. 3 to 6, a first weather strip 81 is provided on an upper surface of the first support portion 25, that is, the first surface 20a facing the panel body 41. An elastic material such as rubber or elastomer is used for the first weather strip 81. The first weather strip 81 has a tubular shape. The first weather strip 81 is continuously provided along the first support portion 25. The first weather strip 81 is fixed to the first support portion 25 using an adhesion of an adhesive or the like. When the panel body 41 is located at a closed position, the first weather strip 81 seals between the panel body 41, that is, the second surface 10b of the roof panel 10 and the first surface 20a of the base panel 20.

A second weather strip 82 is provided on an upper surface of the second support portion 27, that is, the first surface 20a facing the roof panel 10. An elastic material such as rubber or elastomer is used for the second weather strip 82. The second weather strip 82 has a tubular shape. The second weather strip 82 is continuously provided along the second support portion 27. The second weather strip 82 is fixed to the second support portion 27 using an adhesion of an adhesive or the like. When the panel body 41 is located at the closed position, the second weather strip 82 seals a gap between the panel body 41 and the panel opening 11.

The urethane resin 80 is applied to the upper surface of the second support portion 27, that is, the first surface 20a facing the roof panel 10. The urethane resin 80 is continuously provided between the second weather strip 82 and the outer edge 21b along the second support portion 27. The urethane resin 80 fixes the first surface 20a of the base panel 20 to the second surface 10b of the roof panel 10.

The groove 26 is disposed so as to overlap the gap between the panel body 41 and the panel opening 11 in the up-down direction. When the panel body 41 is at the closed position, the groove 26 forms a space S among the panel body 41, the first weather strip 81, and the second weather strip 82. Water entering between the roof panel 10 and the panel body 41 reaches the groove 26, for example. The water that reaches the groove 26 in this manner accumulates in the space S. The water accumulated in the space S does not leak from the groove 26 through the first support portion 25 and the second support portion 27.

As shown in FIGS. 3 and 4, the urethane resin 15 is applied to a part of the second surface 10b of each panel side portion 14, more specifically, to the end portion on the outer side in the width direction. The second surface 10b of the panel side portion 14 is fixed to the vehicle frame 2 via the urethane resin 15. The arm portion of the upper frame 32, which is a portion of the deflector device 30, is accommodated in the groove 26 corresponding to the base side portion 24. In FIG. 3, the guide rail 43 of the panel device 40 is fixed to a front side groove 26a of the groove 26 corresponding to the base side portion 24 via the base bracket 50. The base bracket 50 is fixed to a lower surface of the side groove 26a, that is, the second surface 20b on the vehicle interior side, by a fastening member 51 such as a rivet or a bolt. The guide rail 43 is fixed to an upper surface of the base bracket 50, that is, the first surface facing the roof panel 10, by a fastening member 52 such as a rivet or a bolt. Although not shown, the guide rail 43 is also fixed to the upper surface of the base bracket 50, that is, the first surface facing the roof panel 10. In FIG. 4, the base bracket 50 is not fixed to a rear side groove 26b of the groove 26 corresponding to the base side portion 24.

As shown in FIG. 5, the urethane resin 15 is applied to a part of the second surface 10b of the panel front portion 12, more specifically, a part near the front end. The second surface 10b of the panel front portion 12 is fixed to the vehicle frame 2 via the urethane resin 15. The lower frame 31 and a front portion of the upper frame 32, which are portions of the deflector device 30, are accommodated in the folded state in the groove 26 corresponding to the base front portion 22. That is, the deflector portion 33 is also accommodated in the folded state in the groove 26 corresponding to the base front portion 22.

As shown in FIG. 6, the deflector device 30 is not accommodated in the groove 26 corresponding to the base rear portion 23. The deflector portion 33 is also accommodated in the groove 26 corresponding to the base front portion 22.

As shown in FIG. 7, the urethane resin 15 is applied to a part of the second surface 10b of the panel rear portion 13, more specifically, a part near the rear end. The second surface 10b of the panel rear portion 13 is fixed to the vehicle frame 2 via the urethane resin 15. The panel rear portion 13 includes a fixing portion 13a inside a rear end thereof. The rear portion 66 of the shade device 60, that is, the shade winding portion 62 is fixed to the portion 13a via the panel bracket 70. The panel bracket 70 is fixed to the second surface 10b of the portion 13a by the urethane resin 71. In the embodiment disclosed here, the portion 13a is a portion of the roof panel 10 that is separated from the panel opening 11 and is a portion in a range where the base panel 20 does not exist. A lower surface of the panel bracket 70, that is, a first surface 70a on the vehicle interior side is fixed to the vehicle frame 2 by a fastening member 72 such as a rivet or a bolt. The rear portion 66, that is, the shade winding portion 62 is fixed to the first surface 70a of the panel bracket 70 by a fastening member 73 such as a rivet or a bolt.

### <Detailed Configuration of Groove>

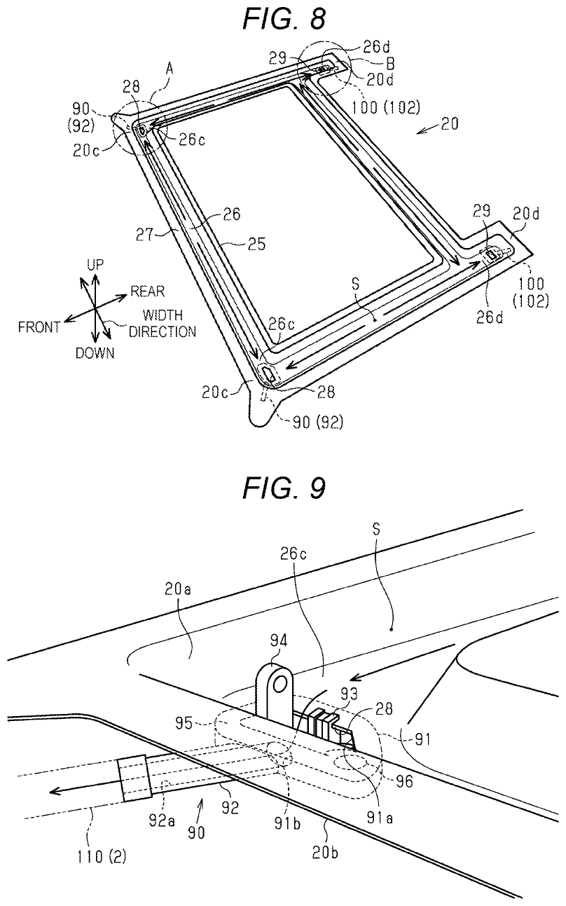

As shown in FIG. 8, the groove 26 includes four groove portions (two front corner groove portions 26c and two rear corner portions 20d) respectively corresponding to the four corners of the base panel 20 as a frame. In the base panel 20, the groove portions 26c and 26d respectively corresponding to the corner portions 20c and 20d are located lower as compared with other portions of the groove 26. This is because the groove 26 is located lower than the first support portion 25 and the second support portion 27, that is, on the vehicle interior side. The water accumulated in the space S flows downward along the groove 26. For example, when the vehicle is placed on a flat horizontal surface, the two front corner portions 20c are the lowest points on the groove 26 extending continuously. In this case, as indicated by arrows in FIG. 8, in the groove 26, the water accumulated in the space S flows toward the two front corner portions 20c. On the other hand, when the vehicle is placed on, for example, an inclined surface (that is, the vehicle is inclined with respect to the horizon), for example, when the front side of the vehicle is located on the upper side with respect to the rear side, the two rear corner portions 20d are the lowest points on the groove 26 extending continuously. In this case, in the groove 26, the water accumulated in the space S flows toward the two rear corner portions 20d as indicated by the arrows in FIG. 8.

A front drain member 90 or a rear drain member 100 is provided at each of the corner portions 20c and 20d. A high molecular material such as a synthetic resin is used for the front drain member 90 and the rear drain member 100. The front drain member 90 and the rear drain member 100 are separate bodies of the base panel 20.

The two front corner groove portions 26c respectively corresponding to the two front corner portions 20c are portions where the base front portion 22 and the two base side portions 24 are connected. The two front corner groove portions 26c are provided with mounting holes 28 penetrating bottoms thereof in a plate thickness direction so as to communicate an inside and an outside of the bottoms. The front drain member 90 is attached to each mounting hole 28.

The two rear corner groove portions 26d respectively corresponding to the two rear corner portions 20d are the portions of the base side portion 24 extending further rearward beyond the base rear portion 23. The two rear corner groove portions 26d are provided with mounting holes 29 penetrating bottoms thereof in the plate thickness direction so as to communicate an inside and an outside of the bottoms. The rear drain member 100 is attached to each mounting hole 29.

### <Configuration of Drain Member>

As shown in FIG. 9 by enlarging a range A in FIG. 8, the front drain member 90 includes a main body portion 91, a connection channel 92, a locking piece 93, and a pillar portion 94. The main body portion 91 has a flat plate shape. A concave portion 91a having a depth in a plate thickness direction from a first surface in the plate thickness direction is provided at a center of the main body portion 91. A shape of an opening of the concave portion 91a is the same as that of the mounting hole 28. The connection channel 92 has a cylindrical shape. The connection channel 92 extends straight from a side surface of the main body portion 91 in a direction orthogonal to the plate thickness direction. A passage port 91b opens in the concave portion 91a. An inside 92a of the connection channel 92 communicates with the inside of the concave portion 91a through the passage port 91b. The locking piece 93 has a claw shape. The locking piece 93 protrudes from the opening of the concave portion 91a in the plate thickness direction. The pillar portion 94 has a pillar shape. The pillar portion 94 protrudes from the opening of the concave portion 91a in the plate thickness direction. The pillar portion 94 has a protruding length larger than that of the locking piece 93.

The front drain member 90 is attached from the second surface 20b side of the front corner groove portion 26c such that the opening of the concave portion 91a coincides with the mounting hole 28. The main body portion 91 is attached to the second surface 20b of the front corner groove portion 26c via a seal member 95. In this case, the locking piece 93 and the pillar portion 94 protrude from the mounting hole 28 toward the first surface 20a side of the front corner groove portion 26c. The locking piece 93 protruding toward the first surface 20a side is locked to a periphery of the mounting hole 28. The main body portion 91 is fixed from the first surface 20a side of the front corner groove portion 26c by a fastening member 96 such as a rivet or a bolt. As a method of fixing the front drain member 90 to the front corner groove portion 26c, for example, only the fastening member 96 can be used, or adhesion of an adhesive or the like can be used, but the method is not limited thereto. Thus, the inside and the outside of the front corner groove portion 26c communicate with each other through the connection channel 92. That is, the inside and the outside of the base panel 20 communicate with each other by the front drain member 90. The connection channel 92 is coupled to a drainage channel 110 provided in a body of the vehicle, that is, the vehicle frame 2.

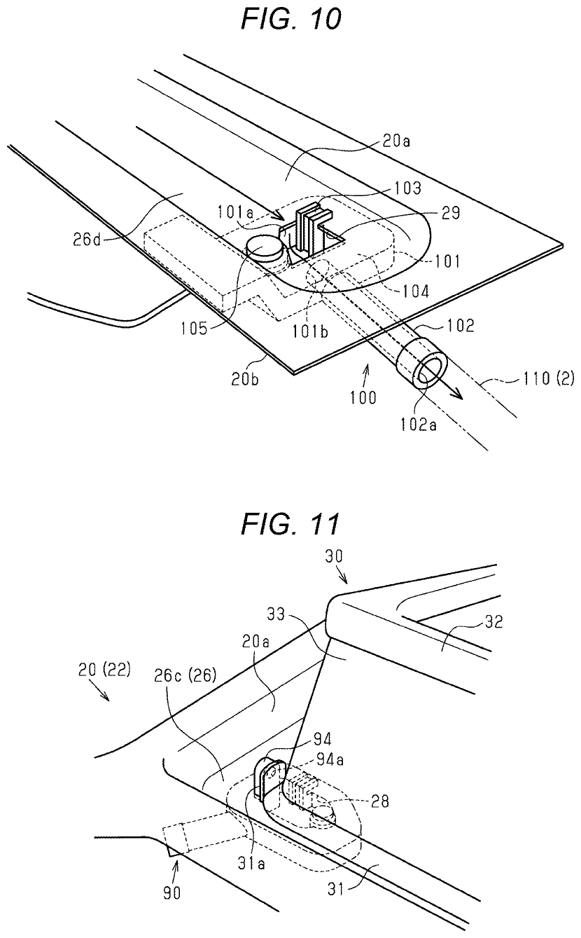

As shown in FIG. 10 by enlarging a range B in FIG. 8, the rear drain member 100 has a configuration corresponding to the front drain member 90 in the configuration other than the pillar portion 94. The rear drain member 100 includes a main body portion 101, a connection channel 102, and a locking piece 103. The main body portion 101 corresponds to the main body portion 91. The connection channel 102 corresponds to the connection channel 92. The locking piece 103 corresponds to the locking piece 93. A shape of an opening of a concave portion 101a of the main body portion 101 is the same as that of the mounting hole 29. The connection channel 102 extends straight from a side surface of the main body portion 101 in a direction orthogonal to the plate thickness direction. An inside 102a of the connection channel 102 communicates with the inside of the concave portion 101a through a passage port 101b provided in the concave portion 101a. The locking piece 103 protrudes from the opening of the concave portion 101a in the plate thickness direction.

The rear drain member 100 is attached from the second surface 20b side of the rear corner groove portion 26d such that the opening of the concave portion 101a coincides with the mounting hole 29. The main body portion 101 is attached to the second surface 20b of the rear corner groove portion 26d via a seal member 104. In this case, the locking piece 103 protrudes from the mounting hole 29 toward the first surface 20a side of the rear corner groove portion 26d. The locking piece 103 protruding toward the first surface 20a side is locked to a periphery of the mounting hole 29. The main body portion 101 is fixed from the first surface 20a side of the rear corner groove portion 26d by a fastening member 105 such as a rivet or a bolt. As a method of fixing the rear drain member 100 to the rear corner groove portion 26d, for example, only the fastening member 105 can be used, or adhesion of an adhesive or the like can be used, but the method is not limited thereto. Thus, the inside and the outside of the rear corner groove portion 26d communicate with each other through the connection channel 102. That is, the inside and the outside of the base panel 20 communicate with each other by the rear drain member 100. The connection channel 102 is coupled to the drainage channel 110 provided in a body of the vehicle, that is, the vehicle frame 2.

As shown in FIG. 11, the lower frame 31 of the deflector device 30 is fixed to the first surface 20a of the groove 26 corresponding to the base front portion 22 including the front corner groove portion 26c. In the front corner groove portion 26c, the pillar portion 94 protrudes from the mounting hole 28 toward the first surface 20a side in a state where the front drain member 90 is attached. The same applies to the other front corner groove portion 26c (not shown). On the first surface 20a of the groove 26 corresponding to the base front portion 22, the two pillar portions 94 protrude from the corresponding mounting holes 28 on both sides in the width direction. The lower frame 31 is supported and fixed to the two pillar portions 94 protruding toward the first surface 20a side. Each of the two pillar portions 94 is provided with a support hole 94a that is open inward in the width direction and has a depth outward in the width direction. The two support holes face each other. The two pillar portions 94 are disposed in the width direction at an interval having substantially the same distance as a length of the lower frame 31 in the axial direction. Both the end portions 31a of the lower frame 31 are inserted into inner peripheral portions of the two support holes 94a from the inner side in the width direction. That is, the two front drain members 90 are attached to the base panel 20 in a state of supporting and fixing the lower frame 31.

### Operation of Embodiment Disclosed Here

According to the embodiment disclosed here, for example, when water enters between the roof panel 10 and the panel body 41, the entering water reaches the groove 26 of the base panel 20. The water that reaches the groove 26 in this manner flows toward each of the corner portions 20c and 20d that can be the lowest point while flowing through the groove 26 after accumulating in the space S.

As indicated by arrows in FIG. 9, in the front corner groove portion 26c, the water accumulated in the space S flows from the mounting hole 28 to the concave portion 91a, and flows to the connection channel 92 through the passage port 91b. The water flowing to the connection channel 92 is subjected to a discharge process to the outside of the vehicle through the drainage channel 110 without leaking to the vehicle interior.

As indicated by arrows in FIG. 10, in the rear corner groove portion 26d, the water accumulated in the space S flows from the mounting hole 29 to the concave portion 101a, and flows to the connection channel 102 through the passage port 101b. The water flowing to the connection channel 102 is subjected to the discharge process to the outside of the vehicle through the drainage channel 110 without leaking to the vehicle interior.

In this manner, the water that reaches the groove 26 is discharged to the outside of the base panel 20 through the connection channels 92 and 102 of the corner portions 20c and 20d that can be the lowest point according to conditions of the vehicle while flowing through the groove 26. The water discharged to the outside of the base panel 20 flows to the drainage channel 110.

### Effects of Embodiment Disclosed Here

(1-1) Water entering between the roof panel 10 and the panel body 41 is discharged from the groove 26 of the base panel 20 to the drainage channel 110 via the connection channels 92 and 102 in this order, so that the water is prevented from entering to the vehicle interior. Accordingly, water entering between the roof panel 10 and the panel body 41 can be appropriately treated.

(1-2) The front drain member 90 and the rear drain member 100 are provided at the corner portions 20c and 20d that can be the lowest points according to the conditions of the vehicle. Accordingly, when the vehicle is placed on a flat horizontal surface, the water that reaches the groove 26 suitably flows to the connection channel 92. On the other hand, when the vehicle is placed on an inclined surface (that is, the vehicle is inclined with respect to the horizon), for example, when the front side of the vehicle is located on the upper side with respect to the rear side, the water that reaches the groove 26 suitably flows into the connection channel 102. Accordingly, water entering between the roof panel 10 and the panel body 41 can be suitably discharged from the groove 26 of the base panel 20.

(1-3) The front drain member 90 can also serve as a configuration for supporting the deflector device 30, that is, the lower frame 31. Accordingly, the configuration can be simplified as compared with a case where the configuration for supporting the deflector device 30 is individually provided.

(1-4) The panel device 40 can be attached to the base panel 20 via the base bracket 50. On the other hand, the shade device 60 can be attached to the roof panel 10 via the panel bracket 70 even in a range where the base panel 20 does not exist. Accordingly, when the panel device 40 and the shade device 60 are provided, each device can be suitably attached to the roof panel 10.

### Other Embodiments

The above embodiment may be modified as follows. In addition, the following other embodiments can be combined with each other within a technically inconsistent range.
The shade device 60 may be attached to the vehicle frame 2 in a range where the base panel 20 does not exist. In this case, the rear portion 66 of the shade device 60, that is, the shade winding portion 62 may be fixed to the vehicle frame 2 using a bracket.
The panel device 40 may be attached to the roof panel 10 in a range where the base panel 20 exists. In this case, the panel device 40 may be fixed to the roof panel 10 using a bracket.
The driving device 63 of the shade device 60 may be attached to the rear portion 66. In this case, the driving device 42 of the panel device 40 may be attached to the front portion 65, or may be attached to the rear portion 66 together with the driving device 63. When the driving device 42 is attached to the rear portion 66, it can be said that the panel device 40 is attached to the roof panel 10 in a range where the base panel 20 does not exist.
The shade device 60 may manually perform the opening operation and the closing operation on the shade 61. The shade device 60 may be omitted.
The front drain member 90 may not include the pillar portion 94. In this case, the groove 26 of the base panel 20 may be used to fix the lower frame 31 of the deflector device 30. The other embodiments described herein can be applied to a case where the deflector device 30 does not include the lower frame 31, and can be applied to a case where the sunroof apparatus 1 does not include the deflector device 30.
The concave portion 91a, the passage port 91b, and the connection channel 92 of the front drain member 90 may be implemented as the front corner groove portion 26c, that is, a part of the base panel 20. That is, the front drain member 90 may be integrated with the base panel 20. The other embodiments described here are also applicable to the concave portion 101a, the passage port 101b, and the connection channel 102 of the rear drain member 100. That is, the rear drain member 100 may be integrated with the base panel 20.
The rear drain member 100 may be omitted. In this case, the mounting hole 29 may not be provided in the rear corner groove portion 26d. That is, in order to treat water entering between the roof panel 10 and the panel body 41, the mounting holes 29 may be provided only in the two front corner portions 20c.
When the vehicle is placed on a flat horizontal surface, the shape of the groove 26 may be, for example, a shape in which a center of a portion corresponding to the base side portion 24 in the front-rear direction is the lowest point. In this case, for example, the rear drain member 100 may be attached to a portion where the center of the base side portion 24 in the front-rear direction is the lowest point. That is, the drain member corresponding to the front drain member 90 or the rear drain member 100 without limiting to the corner portions 20c and 20d may be attached to a portion that can be the lowest point in the groove 26 extending continuously.
The shape of the groove 26 may be a shape divided in the front-rear direction at the center of the portion corresponding to the base side portion 24 in the front-rear direction. Even in this case, at the front side of the base side portion 24 of the groove 26 divided in the front-rear direction, the water reaching the groove 26 is discharged by the two front drain members 90. At the rear side of the base side portion 24 of the groove 26 divided in the front-rear direction, the water reaching the groove 26 is discharged by the two rear drain members 100. In this case, in a state where the vehicle is placed on a flat horizontal surface, the groove 26 may be inclined downward toward the two rear corner portions 20d on the rear side of the base side portion 24 of the groove 26 divided in the front-rear direction.

A shape, size, arrangement, and the like of the roof opening 3a or the panel opening 11 can be appropriately changed.

### REFERENCE SIGNS LIST

1 sunroof apparatus
2 vehicle frame (body)
3 roof
3a roof opening
10 roof panel
11 panel opening
20 base panel
26 groove
30 deflector device
40 panel device
41 panel body
50 base bracket
60 shade device
70 panel bracket
90 front drain member (drain member)
92 connection channel
100 rear drain member (drain member)
102 connection channel
110 drainage channel

1. A sunroof apparatus comprising:
a roof panel attached to cover a roof opening provided in a roof of a vehicle;
a panel body configured to open and close a panel opening provided in the roof panel; and
a base panel attached to an vehicle interior side of the panel opening and extending along a periphery of the panel opening, wherein
a groove is formed between the base panel and the panel body,
the groove has at least one connection channel communicating an inside and an outside of the base panel, and
each connection channel is coupled to a drainage channel provided in a body of the vehicle.

2. The sunroof apparatus according to claim 1, wherein
the groove extends continuously along the base panel, and
the at least one connection channel is provided in a portion that becomes a lowest point in the groove extending continuously.

3. The sunroof apparatus according to claim 2, wherein
the roof opening has a rectangular shape,
an outer shell of the roof panel has a rectangular shape following the roof opening and includes four corners,
when the vehicle is placed on a flat horizontal surface, portions corresponding to the four corners of the roof panel are located lower as compared with a center portion, and portions corresponding to two front corners of the four corners are lowest,
the panel opening has a rectangular shape,
the base panel is a rectangular frame following the panel opening and includes four corner portions,
the groove includes four groove portions respectively corresponding to the four corner portions of the frame,
the four groove portions include two front corner groove portions and two rear corner groove portions, and
the at least one connection channel includes two connection channels that respectively open to the two front corner groove portions.

4. The sunroof apparatus according to claim 3, wherein
the at least one connection channel further includes two connection channels that respectively open to the two rear corner groove portions.

5. The sunroof apparatus according to claim 1, further comprising:
a deflector device configured to prevent air vibration caused by wind being drawn into a vehicle interior when the panel opening is opened, wherein
the deflector device is accommodated in the groove in the base panel,
the at least one connection channel is a part of a drain member provided separately from the base panel, and
the drain member is attached to the base panel in a state of supporting the deflector device.

6. The sunroof apparatus according to claim 1, further comprising:
a panel device configured to perform an opening operation and a closing operation on the panel body; and
a shade device configured to perform an opening operation and a closing operation on a light shielding member provided below the panel body, wherein
the panel device is attached to the vehicle interior side of the base panel via a base bracket in a range of the roof panel where the base panel exists, and
the shade device is attached to the vehicle interior side of the roof panel via a panel bracket in a range of the roof panel where the base panel does not exist.

7. The sunroof apparatus according to claim 2, further comprising:
a deflector device configured to prevent air vibration caused by wind being drawn into a vehicle interior when the panel opening is opened, wherein
the deflector device is accommodated in the groove in the base panel,
the at least one connection channel is a part of a drain member provided separately from the base panel, and
the drain member is attached to the base panel in a state of supporting the deflector device.

8. The sunroof apparatus according to claim 3, further comprising:
a deflector device configured to prevent air vibration caused by wind being drawn into a vehicle interior when the panel opening is opened, wherein
the deflector device is accommodated in the groove in the base panel,
the at least one connection channel is a part of a drain member provided separately from the base panel, and
the drain member is attached to the base panel in a state of supporting the deflector device.

9. The sunroof apparatus according to claim 4, further comprising:
a deflector device configured to prevent air vibration caused by wind being drawn into a vehicle interior when the panel opening is opened, wherein
the deflector device is accommodated in the groove in the base panel,
the at least one connection channel is a part of a drain member provided separately from the base panel, and
the drain member is attached to the base panel in a state of supporting the deflector device.

10. The sunroof apparatus according to claim 2, further comprising:
a panel device configured to perform an opening operation and a closing operation on the panel body; and
a shade device configured to perform an opening operation and a closing operation on a light shielding member provided below the panel body, wherein
the panel device is attached to the vehicle interior side of the base panel via a base bracket in a range of the roof panel where the base panel exists, and
the shade device is attached to the vehicle interior side of the roof panel via a panel bracket in a range of the roof panel where the base panel does not exist.

11. The sunroof apparatus according to claim 3, further comprising:
a panel device configured to perform an opening operation and a closing operation on the panel body; and
a shade device configured to perform an opening operation and a closing operation on a light shielding member provided below the panel body, wherein
the panel device is attached to the vehicle interior side of the base panel via a base bracket in a range of the roof panel where the base panel exists, and
the shade device is attached to the vehicle interior side of the roof panel via a panel bracket in a range of the roof panel where the base panel does not exist.

12. The sunroof apparatus according to claim 4, further comprising:
a panel device configured to perform an opening operation and a closing operation on the panel body; and
a shade device configured to perform an opening operation and a closing operation on a light shielding member provided below the panel body, wherein
the panel device is attached to the vehicle interior side of the base panel via a base bracket in a range of the roof panel where the base panel exists, and
the shade device is attached to the vehicle interior side of the roof panel via a panel bracket in a range of the roof panel where the base panel does not exist.

13. The sunroof apparatus according to claim 5, further comprising:
a panel device configured to perform an opening operation and a closing operation on the panel body; and
a shade device configured to perform an opening operation and a closing operation on a light shielding member provided below the panel body, wherein
the panel device is attached to the vehicle interior side of the base panel via a base bracket in a range of the roof panel where the base panel exists, and
the shade device is attached to the vehicle interior side of the roof panel via a panel bracket in a range of the roof panel where the base panel does not exist.
